(19) United States
(12) Patent Application Publication
(10) Pub. No.: US 2023/0071826 A1
(43) Pub. Date: Mar. 9, 2023

(54) REUSABLE CONTAINER WITH A PROGRAMABLE LABEL AND A TRANSPORT SYSTEM AND METHOD OF USE THEREOF

(71) Applicant: Intertape Polymer Corp., Sarasota, FL (US)

(72) Inventor: James Apap Bologna, Sarasota, FL (US)

(73) Assignee: Intertape Polymer Corp., Sarasota, FL (US)

(21) Appl. No.: 17/939,709

(22) Filed: Sep. 7, 2022

Related U.S. Application Data
(60) Provisional application No. 63/241,272, filed on Sep. 7, 2021.

(51) Int. Cl. G06F 3/0484; B65D 55/14

(52) U.S. Cl. CPC G06F 3/0484; B65D 55/14; B65D 2203/00

(57) ABSTRACT

A reusable container and reusable container transport system for use thereof. The reusable container may include a container housing (e.g., flexible container or ridged container that is reusable, resealable, and/or the like), a programmable screen (e.g., flexible, electrophoretic, and/or the like), a vacuum housing that may be used to secure the screen and/or the other components (e.g., hold, protect, and/or the like), an energy source (e.g., integral with and/or removeable from the container systems), and/or one or more container systems (e.g., low profile motherboard, or the like). When an entity receives the reusable container, the entity may make a product decision using a user interface, such as a user computer system (e.g. a mobile device). The product decision may include acceptance of a product, return of the product, or sending of an alternate product. Based on the product decision the programmable screen may be updated with alternate transport information.

### CROSS REFERENCE AND PRIORITY CLAIM UNDER 35 U.S.C. § 119

This application claims priority to U.S. Provisional Application No. 63/241,272 entitled “Reusable container with a Programable Label and a Transport System and Method of Use Thereof” filed on Sep. 7, 2021, which is assigned to the assignee hereof and the entirety of which is incorporated by reference herein.

### FIELD

The present disclosure relates generally to a reusable container and systems for the use of the reusable container. More specifically, a reusable container with a screen to allow distributors and customers to easily use and reuse the reusable container by easily updating the screen with transport information.

### BACKGROUND

Reusable containers typically require preparation of the containers (e.g., removal of tape or residue, or the like), printing of labels (e.g., access to printers, or the like), requires space to return empty containers. Conventional reusable containers are inefficient, time consuming, and/or difficult to return or reuse.

### BRIEF SUMMARY

The present disclosure relates to a reusable container and reusable container transport system for use thereof. The reusable container may include a container housing (e.g., flexible container or ridged container that is reusable, resealable, and/or the like), a programmable screen (e.g., flexible, electrophoretic, and/or the like), a vacuum housing that may be used to secure the screen and/or the other components (e.g., for holding, protecting, and/or the like the screen and/or the other components), an energy source (e.g., integral or removeable energy source, such as a low voltage battery, printed battery, resonance coil and/or capacitor(s), or the like), and one or more container systems (e.g., low profile motherboard, or the like with memory, processors, communication, or the like components). When a receiving entity (e.g., customer, or the like) receives the reusable container, the receiving entity (e.g., customer, or the like) may make a product decision using an interface (e.g., a physical interface, such as a button, or the like, a voice command interface, a visual interface, a graphical user interface of a user computer system, or the like). The user computer system may comprise a mobile device with an application that allows to the user to interact with the container systems. The product decision may include acceptance of a product, return of the product, or sending of an alternate product. Based on the product decision the programmable screen may be updated with alternate transport information.

It should be understood that embodiments of the invention described herein may be used to transport products between different locations, such as with respect to traditional packaging shipping through the mail; however, it can also be used locally within a facility in which products are moving between locations (e.g., stations, or the like) within a facility or between facilities on a property, such as within warehouses, manufacturing facilities, or the like. As such, while the embodiments of the invention are described generally as a sending user (e.g., distribution user, or the like) providing the container with a product to a receiving user (e.g., customer user, or the like), it should be understood that the embodiments of the disclosure may include any sending user (e.g., any user sending any type of product externally or internally) transporting a product in a container to any receiving user (e.g., any user receiving any type of product externally or internally). As such, the embodiments discussed with respect to a distributor and customer may be replaced with sending user and receiving user. Moreover, while the embodiments may be generally described herein as a sending user transporting a product to the receiving user, these terms may be replaced by sending entity (e.g., a sending user, sending organization, or the like) and receiving entity (e.g., a receiving user, receiving organization, or the like) and the invention described herein may operate in the same or similar way as described herein. As such, the embodiments described herein may operate in many different ways depending on the sending entity that is transporting (e.g., sending, moving, or the like) the product using the reusable container and/or the receiving entity that is receiving the product in the reusable container.

One embodiment of the present disclosure is a reusable container. The reusable container comprising a container housing configured to secure a product a programmable screen operatively coupled to the container, wherein the programmable screen is configured to display transport information, and a container computer system operatively coupled to the programmable screen. The container computer system comprises one or more memory devices with computer-readable program code stored thereon, and one or more processing devices operatively coupled to the one or more memory devices. The one or more processing devices are configured to execute the computer-readable program code to receive replacement transport information based on a product decision from a receiving entity. The replacement transport information corresponds to a container return location for the reusable container, a product return location for the product, or an alternate product location for transporting an alternate product. The one or more processing devices are further configured to execute the computer-readable program code to update the programmable screen with the replacement transport information.

In further accord with embodiments, the replacement transport information is received from an entity interface.

In other embodiments, the replacement transport information received from the entity interface comprises receiving the replacement information from a graphical user interface of a receiving entity computer system.

In yet other embodiments, the one or more processing devices are further configured to execute the computer-readable program code to receive the transport information from a transport system for transporting the product to the receiving entity, and update the programmable screen with the transport information.

In still other embodiments, the programmable screen comprises an electrophoretic screen.

In other embodiments, an energy source is operatively coupled to the container computer system to update the programmable screen, wherein the energy source may be integrally or removably operatively coupled to the container computer system.

In further accord with embodiments, the energy source comprises a low voltage energy supply, a printed battery, or a resonance coil and one or more capacitors.

In other embodiments, the system further comprises a vacuum housing operatively coupled to the container housing, wherein the vacuum housing secures the programmable screen.

In yet other embodiments, the container computer system comprise a low-profile motherboard.

In still other embodiments, the programmable screen provides container information comprising transport information, branding information, and advertisement information.

In other embodiments, the container housing is a flexible container or a ridged container.

In further accord with embodiments, the system further comprises a securing system operatively coupled to the container housing. The securing system comprises a closing device operatively coupled to the container, and a locking device configured for operative coupling with the closing device to aid in preventing use of the closing device.

Another embodiment of the present disclosure is reusable container transport system. The system comprising one or more memory devices with computer-readable program code stored thereon, and one or more processing devices operatively coupled to the one or more memory devices. The one or more processing devices are configured to execute the computer-readable program code to send a product decision from an entity interface to a transport system, wherein the product decision comprises acceptance of a product, return of the product, or sending of an alternate product. The one or more processing devices are further configured to execute the computer-readable program code to receive alternate transport information based on the product decision, wherein the alternate transport information corresponds to a container return location for a reusable container, a product return location for the product, or an alternate product location for transport an alternate product. The one or more processing devices are configured to execute the computer-readable program code to provide the alternate transport information to a container system of a reusable container for updating a programmable screen of the reusable container.

In further accord with embodiments, the programmable screen comprises an electrophoretic screen, and wherein an energy source is integrally or removably operatively coupled to the programmable screen for updating the programmable screen.

In other embodiments, the programmable screen provides container information comprising transport information, branding information, and advertisement information.

Another embodiment of the present disclosure is reusable container transport system. The system comprises one or more memory devices with computer-readable program code stored thereon, and one or more processing devices operatively coupled to the one or more memory devices. The one or more processing devices are configured to execute the computer-readable program code to receive a product decision from an entity interface, wherein the product decision comprises acceptance of a product, return of the product, or sending of an alternate product. The one or more processing devices are further configured to execute the computer-readable program code to identify replacement transport information based on the product decision, wherein the replacement transport information corresponds to a container return location for a reusable container, a product return location for the product, or an alternate product location for transporting an alternate product. The one or more processing devices are further configured to execute the computer-readable program code to provide the replacement transport information to a container computer system of a reusable container or to an entity interface that communicates with the container computer system for updating a programmable screen of the reusable container.

In further accord with embodiments, the programmable screen comprises an electrophoretic screen, and wherein an energy source is integrally or removably operatively coupled to the programmable screen for updating the programmable screen.

In other embodiments, the programmable screen provides container information comprising transport information, branding information, and advertisement information.

Another embodiment of the present disclosure is method of processing reusable containers using a reusable container transport system. The method comprises receiving, by one or more processors, a product decision from an entity interface, wherein the product decision comprises acceptance of a product, return of the product, or sending of an alternate product. The method further comprises identifying, by the one or more processors, replacement transport information based on the product decision, wherein the replacement transport information corresponds to a container return location for a reusable container, a product return location for the product, or an alternate product location for transporting an alternate product. The method also comprises providing, by the one or more processors, the replacement transport information to a container system of a reusable container or to an entity interface that communicates with the container system for updating a programmable screen of the reusable container.

In further accord with embodiments, the programmable screen comprises an electrophoretic screen, and wherein an energy source is integrally or removably operatively coupled to the programmable screen for updating the programmable screen.

To the accomplishment the foregoing and the related ends, the one or more embodiments comprise the features hereinafter described and particularly pointed out in the claims. The following description and the annexed drawings set forth certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

The following figures (sometimes abbreviated as “Fig.” or “Figs.” herein) will now be described by way of example, not by way of limitation, in which:

FIG. 1A illustrates a reusable electronic container block diagram, in accordance with embodiments of the present disclosure.

FIG. 1B illustrates an example reusable container with a programmable screen, in accordance with embodiments of the present disclosure.

FIG. 2A illustrates a flexible material used for the container of the reusable container, in accordance with embodiments of the present disclosure.

FIG. 2B illustrates a ridged material used for the container for the reusable container, in accordance with embodiments of the present disclosure.

FIG. 3 illustrates a portion of the securing device for the reusable container, in accordance with embodiments of the present disclosure.

FIG. 4 illustrates a reusable container network diagram, in accordance with embodiments of the present disclosure.

FIG. 5 illustrates a process flow for using the reusable electronic container and the reusable packing network, in accordance with embodiments of the present disclosure.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

While this disclosure is susceptible to embodiments in many different forms, there is shown in the drawings and will herein be described in detail embodiments of the present disclosure with the understanding that the present disclosure is to be considered as an exemplification of the principles of the present disclosure and is not intended to limit the broad aspect of the present disclosure to the embodiments illustrated.

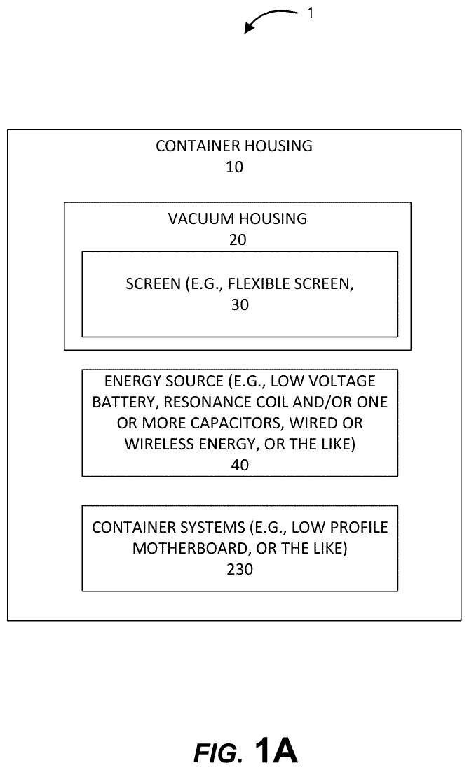

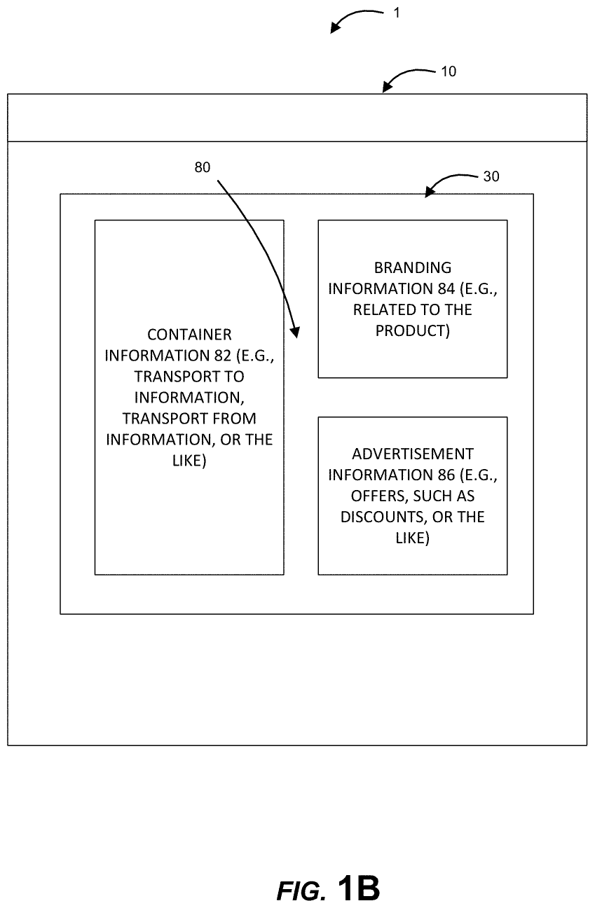

FIG. 1A illustrates a schematic of a reusable container 1 (otherwise described as a reusable electronic container 1, or the like), while FIG. 1B illustrates embodiments of the programmable screen 30 on the reusable container 1. As illustrated in FIGS. 1A and 1B, the reusable container 1 may comprise a container housing 10 (e.g., flexible container, ridged container, or the like that is reusable, resealable, and/or the like), a screen 30 such as an electronic screen (e.g., flexible, electrophoretic, and/or the like screen), a vacuum housing 20 that may be used to secure the screen 30 and/or the other components (e.g., hold, protect, and/or the like), an energy source 40 (e.g., integral or removeable energy source, such as low voltage battery, printed battery, resonance coil and/or capacitor(s), or the like), and one or more container systems 230 (e.g., low profile motherboard, or the like).

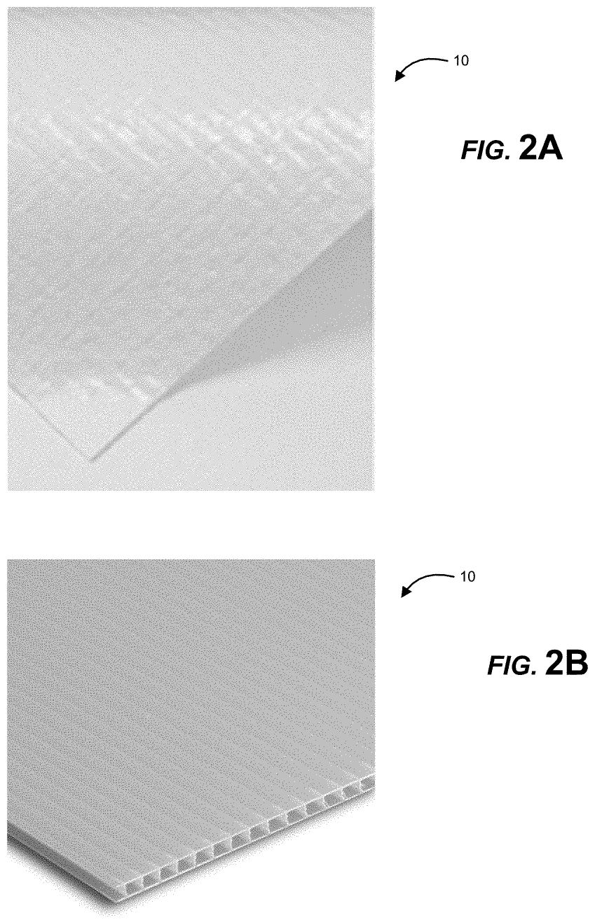

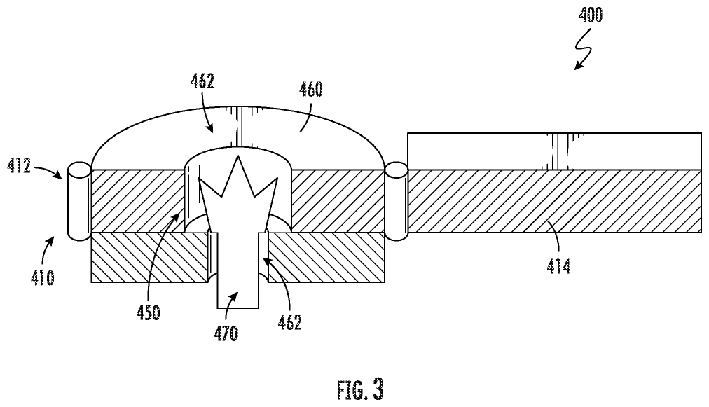

In some embodiments, the container housing 10 may comprise a flexible container (e.g., a mailer, or the like), such as a woven fabric, as illustrated in FIG. 2A, formed into gusseted bags that may have a resealable opening 12. However, it should be understood that any type of material (e.g., woven, non-woven fibers, or the like) may be used for the container housing 10, and may have any type of shape (e.g., gusseted, non-gusseted, envelop, letters, A-style, square, commercial, booklet, catalog, pocket, accordion, or the like). The flexible container housing 10 may allow for collapsing (e.g., folding, rolling, or the like) of the container housing 10 to allow for space savings when returning the reusable container 1. The flexible material may be flame retardant, provide UV stability, water resistant, or the like. The flexible material may include a non-woven material and/or a woven material (e.g., woven scrim) with a film laminated to one or more sides, and/or a coating on one or more sides that enhances abrasion resistance, flex resistance, seam strength, UV resistance and longevity. A woven material (e.g., woven scrim) may enhance flatness, abrasion resistance, and tear properties.

In other embodiments, the container housing 10 may comprise a ridged container, such as a box made from “fluted plastic”, as illustrated in FIG. 2B, made from a polymer (e.g., as a copolymer polypropylene resin, or the like). The fluted plastic provides moisture resistance, and also provides UV protection. As with the flexible container housing 10, it should be understood that any type of material may be used for the ridged container housing 10, and the container housing 10 may have any type of shape (e.g., gusseted, accordion, or the like). The ridged container housing 10 may also be collapsible (e.g., foldable, or the like) onto itself to form a low profile return container to aid in the viability of a returnable reusable container 1.

While the container housing 10 is generally described above as a flexible container housing 10 or a ridged container housing 10, the container housing 10 may have portions that are both flexible and ridged. Also, while the container housing 10 is generally described herein with respect to sending the reusable container 1 having the container housing 10 externally through the mail, the reusable container 1 may be used internally within an entity (e.g., within a warehouse, facility, or the like). As such, the container housing 10 may be any type of container housing 1 of any shape and size that may be transported between to locations as part of an independent transport system (e.g., conveyors, tracks, manual or automatic vehicle, robots, or the like) and/or the container may have its own transport components (e.g., wheels, tracks, motors, or the like). For example, the container housing 10 may be a bin that is transported along a conveyor, that is stored on a vehicle alone or with other bins and transported (manually or automatically) to another location, or the bin itself may have wheels (e.g., manually operated, automatically operated, such as by a motor, or the like) that allows for transport to other locations.

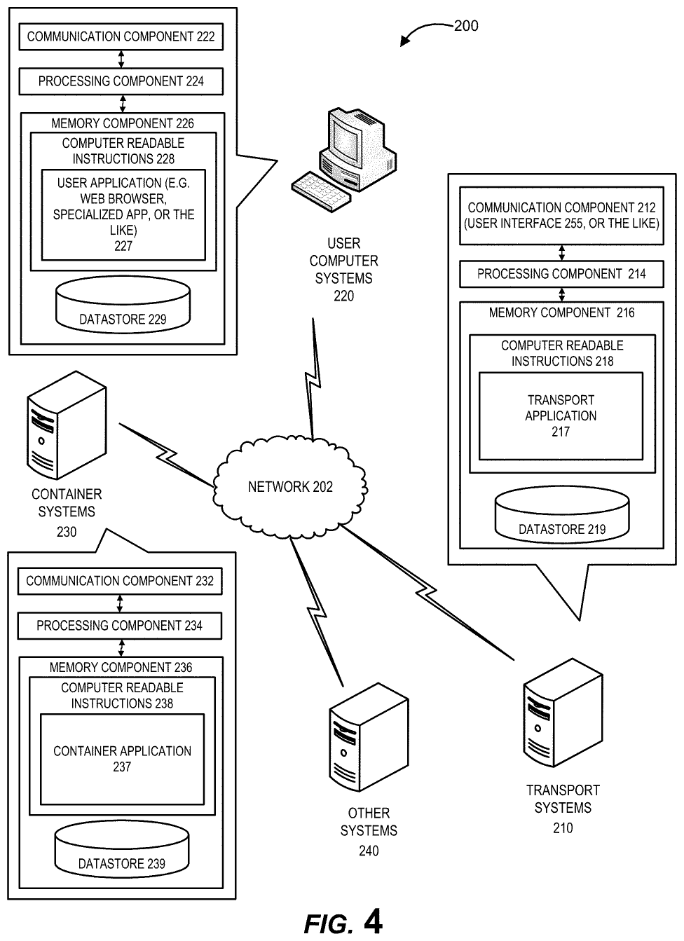

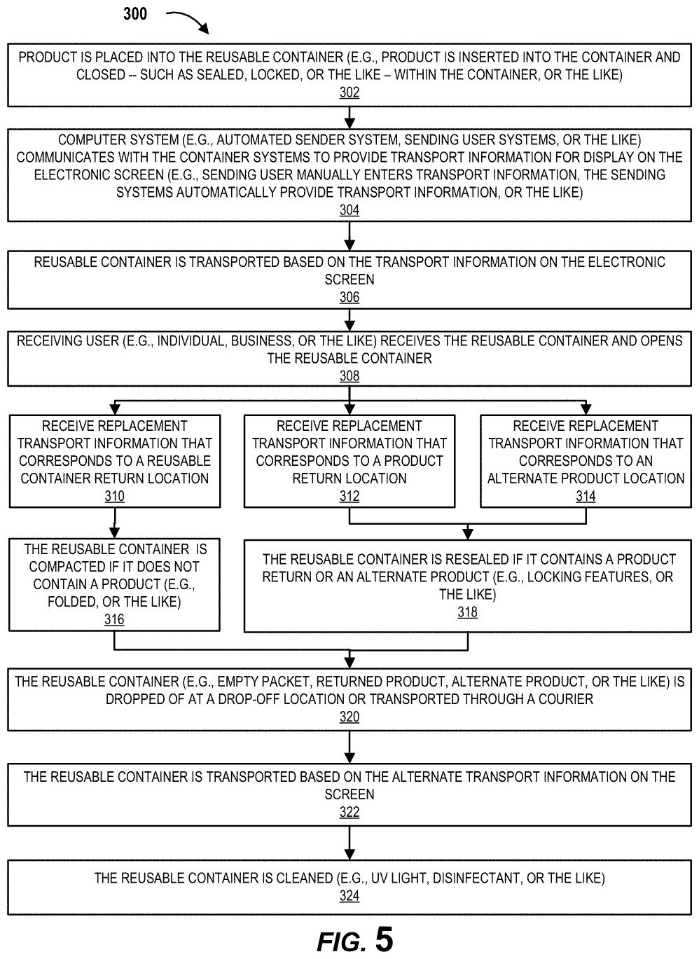

The container housing 10 may comprise a securing system 400, such as but not limited to a closing device 410 and a locking device 450. The closing device 410 may comprise a zipper 412 (e.g., a waterproof, water resistant, or the like), flaps, interlocking fingers, hook and loop, folding, fasteners, pinch seal, and/or the like. The locking device 450 may be used to lock a portion of a closing device 410, such as lock one or more pulls 414 (e.g., a zipper pull, or the like) of a zipper 412. One embodiment of the locking device 450 is illustrated in FIG. 3. As illustrated in FIG. 3, the locking system 450 may comprise a body 460 having one or more body apertures 462 therethrough. Moreover, the container 10 may have a locking portion 452 (e.g., an aperture therethrough, or the like), which may align with the one or more body apertures 462. A locking pin 470 may extend through the body aperture 462 and/or the locking portion 452 (e.g., a container locking aperture 452) such that securing system 400 cannot be opened without breaking the locking pin 470 (e.g., with barbs, or other locking features). While the securing system 400 is described and illustrated with respect to a zipper 412, a pull 414, a locking body 460, a container locking portion 452, and/or a locking pin 470, it should be understood that the securing system 400 may be any type of securing system 400. In some embodiments the reusable container 1 may include a plurality of locking systems 450 (e.g., locking pins 470, or the like) so that each user may return a product and/or send an alternate product to the same or another entity (e.g., organization, individual user, or the like), as will be described in further detail with respect to FIG. 5.

It should be understood that in some embodiments, the securing system 400 may be tracked through the use of the transport systems 200 and/or the container systems 230. For example, the securing system 400 may have a locking identifier (e.g., a barcode, RFID, string of characters, QR code, or the like manual or electronic identifier), such that when the reusable container 1 is packed with a product and the securing system 400 is secured, the locking identifier may be used to log that the securing system 400 was engaged. For example, a locking pin 470 may have a locking identifier that indicates that is being used to secure the container 1. Should a first locking pin be tampered with, and the container 1 is opened by a misappropriator, the misapproporator cannot simply use a substitute locking pin to re-secure the container 1. As such, in some embodiments, a user may be able to automatically (e.g., through RFID, or the like) or manually (e.g., scan the locking identifier, read the locking identifier, or the like) when the reusable container 1 is received in order to determine if the container 1 has been tampered with during transit. In other embodiments, the locking system 450 may be a combination of a mechanical locking mechanism and a virtual lock for which only the receiving user receives the combination (e.g., unique code, or the like) for the lock through an application on the receiving user computer system 220 when the container 1 is shipped to, or received by, the user (e.g., the customer, or the like). In other embodiments, the locking system 450 is an electronic lock that can only be opened by the receiving user through the use of an application on the user computer systems 220 (e.g., communication with the lock of the reusable container 1, or the like).

As previously discussed, the screen 30 may be a flexible screen that is housed in a housing 20 (e.g., a vacuum housing, or the like) that is used to secure the screen 30 (e.g., hold, protect, and/or the like). The housing 20 may provide stability, waterproofing, shatter-resistance, tear resistance, or the like for the screen 30. The screen 30 may be an electrophoretic screen that comprises “electronic ink”, such as a plurality of capsules having pigment therein, which is adhered to one or more sheets of film (e.g., plastic, glass, fibers, or the like). When a charge is applied to the electronic ink, the pigment may move to create a dark or light state for the capsule. While the screen 30 may be an electrophoretic screen, in other embodiments of the invention, the screen may be another type of electronic screen.

The screen 30 may be operatively coupled to container computer systems 230 (otherwise described herein as container systems 230), as will be described in further detail herein. The container computer systems 230 may comprise a low-profile motherboard (or other configuration of components) designed to have one or more communication devices to receive information from a source (e.g., a user interface such as one or more user computer systems 220, one or more transport systems 210, or other systems 240, as will be described herein).

The screen 30 may be further operatively coupled to an energy source 40. The energy source 40 may be integral with the container 1 (e.g., a component thereof), or the energy source 40 may be removeable (e.g., wired or wireless energy source) that is only used when making changes to the information on the screen 30. For example, the energy source 40 may be a low voltage battery (e.g., rechargeable, printed battery, or the like). It should be understood that in some embodiments the voltage may be as low as 5 Volts; however, it should be understood that the voltage may be 1, 2, 3, 4, 5, 6, 7, 8, 9, 10, 11, 12, 13, 14, 15, 16, 17, 18, 19, 20, 25, 30, or the like volts, or may range between, overlap, or fall outside of any of the forgoing. In other embodiments of the invention, the energy source 40 that is used to power the container systems 230, the screen 30, or other components may be any type of energy source, such as resonance coil and/or one or more capacitors, or any other type of energy source. The energy source may also be a wired and/or wireless energy source that may be operatively coupled to the container 1 to change the information on the screen 30, and then removed or turned off after the information is changed.

As such, the container computer systems 230 may use the energy source 40 to charge the capsules in a pattern in order to provide information on the screen 30, such as transport information as will be described herein. After being charged the “electronic ink” remains in a static state until such time as the new information is transmitted through the container system 230.

In some embodiments of the invention, the reusable container 1 may comprise of the container housing 10 and the programmable screen 30 without the container computer systems 230 and/or other components. For example, in order to change the container information 80 on the programmable screen 80, a computer system (e.g., user computer system 220, or the like) may be operatively coupled to the programmable screen 30 through the use of a wired connection (e.g., USB, lightning, or other like communication connection). As such, the computer system provides the energy source, as well as the code, required to update the programmable screen 30. In some embodiments, the screen 30 may have a processor and/or memory. The computer system (e.g., user computer system 220, or the like) may be moved near the electronic screen (e.g., adjacent to, touching a component thereof, or the like) such that the computer system may power (e.g., wireless charging) and/or communicate with the processor wirelessly in order to change the information on the programmable screen 30 (e.g., through near-field communication, Wifi, Zigbee, or the like).

As illustrated in FIG. 1B, the screen 30, the container computer system 230, and/or other components may be utilized to provide on the screen 30 of the reusable container 1 container information 80, such as transport information 82 (e.g., transport to, transport from, or the like, or initial transport, return transport, new transport, or the like information). The transport information may be information related to where the product in the container housing 10 is being sent. For example, with respect to sending the container 1 externally to another location (e.g., through the mail, delivery entities, or the like), the transport information may be traditional shipping information (e.g., name, address, barcode, QR code, or the like) that is used by a shipper to transport the container 1 through traditional shipping facilities. In other examples, with respect to sending the container 1 to a different location within a warehouse, facility, location on a property, the transport information may include internal information regarding where the container 1 is to be delivered. In some embodiments the container information 80 may include branding information 84, such as information related to the product inside, the company that manufactured, distributed, or the like the product. The container information 80 may also include advertisement information 86, such as advertisements from third-parties that may provide third-party products related to the product being shipped, and/or related to the user receiving the product in the reusable container 1.

FIG. 4 illustrates a reusable container transport system 200, in accordance with embodiments of the present disclosure. As illustrated in FIG. 4, one or more transport systems 210 are operatively coupled, via a network 202, to one or more user computer systems 220, one or more container systems 230, and/or one or more other systems 240 (e.g., third party systems, or the like). In this way, the transport systems 210 may communicate with the one or more user computer systems 220, container systems 230, and/or one or more other computer systems 240 for using the reusable container 1, such as transporting, processing, cleaning, updating transport information 82 (or other container information 80) on the screen 30, and/or the like for the reusable container 1, as will be described in further detail herein. Moreover, transport systems 210 may communicate with user computer systems 220 to allow the user computer systems 220 to update the transport information 80 on the screen 30 of the reusable container 1. While the computer systems 210, 220, 230, 240 are illustrated as separate systems, it should be understood that two or more of the systems may be combined such that the system operates as single system, and/or the individual systems 210, 220, 230, 240 may be split into additional systems.

The communications between the systems 210, 220, 230, 240 may occur over a network 202. The network 202 may be a global area network (GAN), such as the Internet, a wide area network (WAN), a local area network (LAN), or any other type of network or combination of networks. The network 202 may provide for wireline, wireless, or a combination of wireline and wireless communication between systems, servers, components, and/or devices on the network 202.

As illustrated in FIG. 4, the one or more transport systems 210 may generally comprise one or more communication components 212, one or more processing components 214, and one or more memory components 216. The one or more processing components 214 are operatively coupled to the one or more communication components 212, and the one or more memory components 216. As used herein, the term “processing component” generally includes circuitry used for implementing the communication and/or logic functions of a particular system. For example, a processing component may include a digital signal processor component, a microprocessor component, and various analog-to-digital converters, digital-to-analog converters, and other support circuits and/or combinations of the foregoing. Control and signal processing functions of the system are allocated between these processing components according to their respective capabilities. The one or more processing components may include functionality to operate one or more software programs based on computer-readable instructions thereof, which may be stored in the one or more memory components.

The one or more processing components 214 use the one or more communication components 212 to communicate with the network 202 and other components on the network 202, such as, but not limited to, the components of the one or more user computer systems 220, the one or more container systems 230, and/or the one or more other computer systems 240. As such, the one or more communication components 212 generally comprise a wireless transceiver, modem, server, electrical connection, electrical circuit, or other component for communicating with other components on the network 202. The one or more communication components 212 may further include an interface that accepts one or more network interface cards, ports for connection of network components, Universal Serial Bus (USB) connectors, lightning connectors, USB-C connectors, HDMI connectors, or the like. Moreover, the one or more communication components 212 may include a keypad, keyboard, touch-screen, touchpad, microphone, mouse, joystick, other pointer component, button, soft key, and/or other input/output component(s) for communicating with the users 204. In some embodiments, as described herein the one or more communication components 212 may comprise a user interface, such as a graphical user interface that allows a user 204 to utilize the transport systems 210.

As further illustrated in FIG. 4, the one or more transport systems 210 comprise computer-readable instructions 218 stored in the one or more memory components 216, which in some embodiments includes the computer-readable instructions 218 of the one or more transport applications 217 (e.g., used to control the transport of the reusable container 1, or the like). In some embodiments, the one or more memory components 216 include one or more data stores 219 for storing data related to the one or more transport systems 210, including, but not limited to, data created, accessed, and/or used by the one or more transport systems 210 to manage the one or more reusable containers 1.

As illustrated in FIG. 4, one or more user computer systems 220 may communicate with each other, the one or more transport systems 210, the one or more container systems 230, and/or other computer systems 240 in order to manage the reusable container 1. Consequently, the one or more users 204 may be users of an organization (e.g., employees, agents, representatives, officers, or the like) of an organization that is initially packaging a product in the reusable container 1, transporting the reusable container 1, processing the reusable container 1 after return of the reusable container 1 (e.g., with a returned product, empty, with an alternate product, or the like), or the like. Moreover, the one or more users 204 may be a receiving user, such as a user that is receiving the reusable container 1 (e.g., a customer user, employee user, or the like), and thereafter returning a product, returning an empty reusable container 1, using the reusable container 1 to send an alternate product, or the like. The one or more user computer systems 220 may be a desktop, laptop, tablet, mobile device (e.g., smartphone device, wearable device—watch, glasses, gloves, implant, or the like, or any other type of mobile device), or any other type of computer that generally comprises one or more communication components 222, one or more processing components 224, and/or one or more memory components 226.

The one or more processing components 224 are operatively coupled to the one or more communication components 222, and the one or more memory components 226. The one or more processing components 224 use the one or more communication components 222 to communicate with the network 202 and other components on the network 202, such as, but not limited to, the one or more transport systems 210, the one or more container systems 230, and/or the other systems 240. As such, the one or more communication components 222 generally comprise a wireless transceiver, modem, server, electrical connection, or other component for communicating with other components on the network 202. The one or more communication components 222 may further include an interface that accepts one or more network interface cards, ports for connection of network components, Universal Serial Bus (USB) connectors, lightning connectors, USB-C connectors, HDMI connectors, and the like. Moreover, the one or more communication components 222 may include a keypad, keyboard, touch-screen, touchpad, microphone, mouse, joystick, other pointer component, button, soft key, and/or other input/output component(s) for communicating with the users. In some embodiments, the one or more communication components 222 may comprise a user interface, such as a graphical user interface that allows a user to, locally or remotely, manage the reusable container 1.

As illustrated in FIG. 4, the one or more user computer systems 220 may have computer-readable instructions 228 stored in the one or more memory components 226, which in some embodiments includes the computer-readable instructions 228 for user applications 227, such as dedicated applications (e.g., apps, applet, or the like), portions of dedicated applications, a web browser or other apps that allow access to applications located on other systems, or the like. In some embodiments, the one or more memory components 226 include one or more data stores 229 for storing data related to the one or more user computer systems 220, including, but not limited to, data created, accessed, and/or used by the one or more user computer systems 220. The user application 227 may use the applications of the one or more transport systems 210, the one or more container systems 230, and/or one or more other computer systems 240 in order to communicate with other systems on the network 202 and take various actions described herein with respect to the reusable container 1 and the use thereof. The user computer applications may include operating platforms (e.g., IOS, Android, or the like) that allow for the use of program applications, such as the applications that control the processes described herein (e.g., tracking, updating, and managing the reusable packing through the transport cycles).

It should be understood that the embodiments described herein typically discuss using a user computer system 220, such as a graphical user interface of the user computer system 220, to implement and use the reusable container 1 described herein. However, it should be understood that the embodiments described herein may be implemented through any type of user interface, such as a physical interface comprising a button, switch, or other physical interface, a voice command interface that can determine voice commands, a visual interface that can determine user gestures, or other like interface that is used by the user in order accept the product, return the product, and/or transport a new product. For example, with respect to products moving around a warehouse and/or manufacturing facility, the user interface may include a plurality of buttons that allow a user to press a button in order to decision a product received from a container 1 (e.g., accept, reject, send to a different location, or the like). After making a selection, the programmable screen 30 may be updated with the desired information based on the user decision. The use of the user computer system 220 to implement a decision for a product received will be discussed in further detail herein.

Moreover, as illustrated in FIG. 4, the one or more container systems 230 may communicate with the transport systems 210, the user computer systems 220, and/or other computer systems 240 in order to receive information from and/or send information to the other systems over the network 202 to allow for reuse of the container 1. Consequently, the one or more container systems 230 may generally comprise one or more communication components 232, one or more processing components 234, and one or more memory components 236.

The one or more processing components 234 are operatively coupled to the one or more communication components 232, and the one or more memory components 236. The one or more processing components 234 use the one or more communication components 232 to communicate with the network 202 and other components on the network 202, such as, but not limited to, the one or more transport systems 210, the one or more user computer systems 220 (or other user interface), and/or the other computer systems 240. As such, the one or more communication components 232 generally comprise a wireless transceiver, modem, server, electrical connection, or other component for communicating with other components on the network 202. The one or more communication components 232 may further include an interface that accepts one or more network interface cards, ports for connection of network components, Universal Serial Bus (USB) connectors, lightning connectors, USB-C connectors, HDMI connectors, and the like. Moreover, the one or more communication components 232 may include a keypad, keyboard, touch-screen, touchpad, microphone, mouse, joystick, other pointer component, button, soft key, and/or other input/output component(s) for communicating with the users 204. In some embodiments, the one or more communication components 232 may comprise a screen 30 that provides a user interface, such as a graphical user interface that is configured to receive and/or display information on the screen 30.

As illustrated in FIG. 4, the one or more container systems 230 may have computer-readable instructions 238 stored in the one or more memory components 236, which in some embodiments includes the computer-readable instructions 238 for a container application 237, such as dedicated applications (e.g., apps, applet, or the like), portions of dedicated applications, a web browser or other apps that allow for receipt of information and/or sending of information over the network 202. In some embodiments, the one or more memory components 236 include one or more data stores 239 for storing data related to the one or more container systems 230, including, but not limited to, data created, accessed, and/or used by the one or more container systems 230. The container application 237 may communicate with the applications of the one or more transport systems 210, the one or more user computer systems 230, and/or one or more other computer systems 240 in order to communicate with other systems on the network 202 and take various actions described herein related to managing the reusable container 1.

Furthermore, the other computer systems 240 (e.g., third party systems, or the like), which may be used to process, transport, clean, reuse, or the like the reusable container 1, may have components similar to the components described with respect to the one or more transport systems 210, the one or more user computer systems 220, and/or the one or more container systems 230 (e.g., one or more communication components, one or more processing components, one or more memory components with computer-readable instructions of one or more applications, one or more datastores, or the like). Thus, the one or more other computer systems 240 communicate with the one or more transport systems 210, the one or more user computer systems 220, and/or one or more container systems 230 in same or similar way as previously described with respect to the one or more transport systems 210, the one or more user computer systems 220, and/or the one or more container systems 230.

FIG. 5 illustrates a process for using and reusing the reusable container 1 described herein. As illustrated in block 302 of FIG. 5, a product is placed (e.g., packed, or the like) into a reusable container 1. In some embodiments the product is inserted into the container and closed, such as closed and locked as previously discussed herein with respect to securing system 400. As such, the product may be secured within the reusable container 1, such that tampering of the securing device 400 may be identified. As previously discussed, the entity packing the product in the reusable container 1 may capture and store the locking identifier in order to provide the information to the customer receiving the container 1, such that the customer can confirm whether or not the container 1 has been tampered with before receipt by the customer.

Block 304 illustrates that a computer system may communicate with the container computer system 230 of the reusable container 1 in order to provide container information 80 (e.g., transport information 82, branding information 84, advertising information 86, or the like) on the screen 30 of the reusable container 1. The computer system that communicates with the container computer systems 230 to provide the information may be sender user computer system 220 of a sending user. In some embodiments the computer system may be a transport system 210 of a distributer system (e.g., a third-party system 240) of a distributer (e.g., manufacturer, distributor, supplier, or the like) that communicates with the container systems 230 before, during, and/or after the product is being packaged. In some embodiments computer system (e.g., the sending user computer system 220, the distributer system, or the like) may communicate with the container systems 230 directly, through the use of the transport systems 210 (e.g., provider of the transport application, reusable container 1, and/or the like), through a user computer system 220 (e.g., employee or other user associated with and organization, such as a distributor, or the like), or the like. For example, the computer system (e.g., sending user computer system 220, distributor systems, or the like) may automatically update the container information, or a user 204 may manually update the container information. Regardless of the type of computer system that communicates with the container systems 230, the computer system may indicate to the container systems 230 the container information to display on the screen 30, and in response the energy source 40 may be activated in order to display the container information 80 on the screen 30 (e.g., activate the electrophoretic screen, or the like).

It should be understood that the container information 80 may be based on the courier that will be transporting the reusable container 1. As such, the container information 80 may be customized based on the entities related to the reusable container 1 (e.g., distributor, customer, courier, owner of the reusable container 1, or the like). In some embodiments, the container information on the screen 30 may only be changed by the computer system, such as the sending user computer system and/or the distributor system (e.g., distributor system, a distributor user computer system associated with the distributor system, or the like) that provided the container information 80, or a receiving user computer system (e.g., receiving user computer system 220, customer system, or the like) that will receive the reusable container 1, as will be discussed with respect to Blocks 310-314.

FIG. 5 further illustrates in block 306, that the reusable container 1 is transported (e.g., shipped, or the like) based on the transport information 82 provided on the screen 30 of the reusable container 1. It should be understood that the reusable container 1 may be shipped by any courier (e.g., government courier, private courier, or the like) using traditional transport processes because the reusable container 1 may be customizable based on the transport process.

Block 308 of FIG. 5 further illustrates that the receiving user (e.g., customer, or the like) receives the reusable container 1. Once the delivery of the reusable container 1 is made, the delivery may be confirmed by the courier by sending a notification (e.g., e-mail, application notification, or the like) to the sending user (e.g., distributor, or the like) and/or the receiving user (e.g., customer user, customer entity, or the like), through a system and/or a user system thereof. The receiving user opens the reusable container 1 by opening the securing system 400. In some embodiments, during, before, or after the receiving user opens the securing system 400, the receiving user may determine if the container 1 has been tampered with through the use of the locking identifier (e.g., scan the identifier, communicating with the identifier, receiving a signal from the securing system 400, manually reading the identifier, or the like). The receiving user (e.g., customer, or the like) may be open the securing system 400, for example, by breaking the locking pin 470. In other embodiments, as previously described herein, the locking device 450 may be opened using a combination sent to the receiving user computer systems 220, such as the customer user computer systems 220. In other embodiments, as previously described herein, the locking device 450 may be opened through the receiving user computer systems 220, such as customer user computer systems 220 communicating with an electronic lock.

Once the reusable container 1 is opened, the receiving user may then decide to accept the product, return the product, or send out an alternate product (e.g., return a different product, send a different product to a third-party). As such, in some embodiments, the receiving user may use a user interface (e.g., a physical button, the user computer systems 220, or the like) to decision the product (e.g., accept and return the container, accept and send an alternate product, decline and return the product, or the like) through the transport application or another application.

As illustrated in block 310 of FIG. 5, should the user accept the product, the acceptance may be communicated through the transport application to the sending user (e.g., distributor, or the like). Moreover, container information 80 may then be provided to the receiving user (e.g., the customer), through the user computer systems 220 for the return of the empty reusable container 1. For example, a signal from the sending user systems (e.g., distributor systems, or the like), the transport systems 210, or the like may be provided through the receiving user computer systems 220 who may be located near, or in some embodiments remotely, from the reusable container 1. The signal may provide alternate container information, such as converting at least a portion of the container information located on the screen 30 of the reusable container 1, as previously discussed with respect to block 304. That is, an energy source 40 may be activated to apply a charge to the electronic ink of the screen 30 to provide alternate container information 80, such as updated transport information 82 for the return of the empty reusable container 1. Moreover, the signal, or a different signal (e.g., simultaneously, or the like) may provide a notification to the receiving user computer system 220 regarding how to return the reusable container 1. For example, the notification may include instructions for collapsing the reusable container 1, or such instructions may be provided on the reusable container 1 itself. The notification may also include information regarding what to do with the reusable container 1, that is, for example placing it outside the user's location (e.g., customer's residence, or the like) for pick-up by a courier, dropping the collapsed reusable container 1 at a dedicated location, one of a plurality of potential locations, or the like.

As illustrated by block 312 in FIG. 5, should the user reject the product and want to return the product, then the rejection and return may be communicated through the transport application and/or another application to the sending user (e.g., distributor, or the like) as previously described with respect to block 310. However, instead of receiving a signal with container information 80 for returning the collapsed reusable container 1, the container information 80 may include transport information 82 for returning the product in the reusable container 1 to the sending user (e.g., distributor, or the like) or a third-party entity that handles returns for the distributor.

Alternatively, as illustrated by block 314 in FIG. 5, should the receiving user accept the product but indicate that the receiving user would like to transport an alternative product (e.g., return another product to the distributor, use the reusable container 1 to send a different product to another entity, or the like), the acceptance and request for transporting an alternate product may be communicated through the transport application and/or another application to the sending user (e.g., distributor, or the like) and/or the transport systems 210. As such, the receiving user computer systems 220 may receive a signal with container information 80 for sending the alternate product to the sending user (e.g., distributor, or the like) or a third-party entity. As previously discussed with respect to blocks 310 and 312, the container information 80 may include transport information 82 for returning or sending an alternate product in the reusable container 1 to the sending user (e.g., distributor, or the like) or a third-party entity.

As illustrated by block 316, in response to the indication that the receiving user (e.g., customer, or the like) will be sending an empty reusable container 1 back, as previously described herein with respect to block 310, the receiving user may collapse the reusable container 1 in accordance with the instructions (e.g., on the reusable container 1, in the notification on the user computer system 220, or the like).

Alternatively, as illustrated by block 318 of FIG. 5, in response to an indication that the product will be returned, or an alternative product will be sent, the receiving user (e.g., customer, or the like) may pack the product or an alternative product into the reusable container 1. Moreover, the receiving user (e.g., customer) may secure the reusable container 1 using the securing device 400 (e.g., the locking device 450, as previously discussed herein), including capturing a new locking identifier for the locking device 450. The locking identifier may be used by the next entity receiving the product to make sure the container has not been tampered with. In some embodiments, a new locking pin 470 may be used to secure the reusable container 1. In other embodiments, the locking device 450 may be a combination lock, an electronic lock, or the like).

Block 320 illustrates that the collapsed reusable container 1 and/or the reusable container 1 with the returned product or an alternate product is set (e.g., dropped-off, set outside the residence, or the like) for pick-up. In some embodiments, the transport systems 210 may track the location of a number of reusable containers 1, as such when one or more reusable containers 1 are identified in a pick-up location (e.g., in particular, when a plurality of reusable containers 1 have be identified at a pick-up locations), a notification may be sent to route a user (e.g., specific courier, general courier, contract courier, or the like) to pick-up the reusable container(s) 1 from the customer and/or a pick-up location for transport (e.g., to a warehouse location, to government or private courier, for further processing and/or transport, or the like).

As illustrated by block 322, the reusable container 1 (e.g., collapsed and/or with an alternate product) is shipped in accordance with the new transport information 82 (e.g., specific carrier, back to the distributor, to a new-third party, a cleaning location, or the like) included on the screen 30 of the reusable container 1.

As illustrated in block 324, after the reusable container 1 (e.g., collapsed container, container with returned or alternate product, or the like) is received it may be cleaned by the entity (e.g., distributor, third-party, new customer, or the like). For example, the reusable container 1 may be uncollapsed and/or opened and subjected to UV light, disinfectant, or the like to clean the reusable container 1. In other embodiments, the entity receiving the returned product may restock the returned product and thereafter clean the reusable container 1, as previously described. In still other embodiments, the entity receiving the alternate product may proceed with the same process previously described with respect to blocks 308 and 320.

Regardless of the process described herein, the reusable container 1 is used and returned and/or reused multiple times and the screen 30 of the reusable container 1 adopts its new destination every time it engages with each of the entities (e.g., distributor, customer, or the like users or organizations). As such, the present invention provides for improvements over conventional processes for returning and/or reusing a container, which requires printing labels and taking initiative to return the container. Furthermore, in some embodiments conventional reusable container requires removal and replacement of sealing tape, which increases the inconvenience with a conventional reusable container. The present invention may be a particular benefit with the emergence of same day, multi-hour, same hour or the like delivery through the use of mini regional or local distribution centers (e.g., RDCs, LDCs, or the like) because the reusable container 1 may be returned to local RDCs or LDCs that reduce the time it takes to transport collapsed reusable container 1, thus decreasing the costs associated with reusable container process 300. Moreover, in the embodiments where the energy source 40 is not a battery and/or removeable from the reusable container 1, the present invention provides additional safety because batteries are not being transported with the reusable container 1. As such, the embodiments of the present disclosure provide a simplified engagement process with the re receiving entity, delivers an improved entity (e.g., customer) experience related to sustainability of ecommerce containers, and allows entities (e.g., distributors) to meet sustainability efforts for shareholders, consumers, and government regulations.

Moreover, the particular reusable container 1 described herein provides viable reusable container 1 for both rigid containers as a replacement for traditional kraft or corrugated boxes, as well as reusable flexible containers as a replacement for single use envelops or pouches, such as Mand Pouches.

As will be appreciated by one of skill in the art in view of this disclosure, embodiments of the invention may be embodied as an apparatus, a system, computer program product, and/or other device, a method, or a combination of the foregoing. Accordingly, embodiments of the invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the invention may take the form of a computer program product comprising a computer-usable storage medium having computer-usable program code/computer-readable instructions embodied in the medium (e.g., a non-transitory medium, or the like).

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the invention may be written in an object oriented, scripted or unscripted programming language such as Java, Pearl, Python, Smalltalk, C++ or the like. However, the computer program code/computer-readable instructions for carrying out operations of the invention may also be written in conventional procedural programming languages, such as the “C” programming language or similar programming languages.

Several alternative examples have been described and illustrated herein. A person of ordinary skill in the art would appreciate the features of the individual embodiments and the possible combinations and variations of the components. A person of ordinary skill in the art would further appreciate that any of the examples could be provided in combination with the other examples disclosed herein. Additionally, the terms “first,” “second,” and “third” as used herein are intended for illustrative purposes only and do not limit the embodiments in any way.

As used herein, the singular forms “a”, “an” and “the” are intended to include the plural forms as well, unless the context clearly indicates otherwise. It will be further understood that the terms “includes” and/or “including” when used herein, specify the presence of stated features, steps, operations, elements, and/or components, but do not preclude the presence or addition of one or more other features, steps, operations, elements, components, and/or groups thereof.

It will be understood that when an element is referred to as being “operatively coupled” (other similar phrase) to another element, the elements can be formed integrally with each other, or may be formed separately and put together. Furthermore, “operatively coupled” to can mean the element is directly engaged or operatively coupled to the other element, or intervening elements may be present between the elements. Furthermore, “operatively coupled” may mean that the elements are detachable from each other, or that they are permanently coupled together.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and should not be interpreted in an idealized or overly formal sense unless expressly so defined herein. Certain terminology is used herein for convenience only and is not to be taken as a limitation on the invention. For example, words such as top, bottom, front, rear, side, upper, lower, left, right, horizontal, vertical, upward, and downward merely describe the configuration shown in the figures. The referenced components may be oriented in an orientation other than that shown in the drawings and the terminology, therefore, should be understood as encompassing such variations unless specified otherwise. All structural and functional equivalents to the elements of the various aspects described throughout the disclosure that are known or later come to be known to those of ordinary skill in the art are expressly incorporated herein by reference and are intended to be encompassed by the claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or combined into multiple software/hardware products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, the subject matter lies in less than all features of a single disclosed configuration or operation. The claims are hereby incorporated into the detailed description, with each claim standing on its own as a separately claimed subject matter.

What is claimed is:

1. A reusable container comprising:
a container housing configured to secure a product;
a programmable screen operatively coupled to the container, wherein the programmable screen is configured to display transport information;
a container computer system operatively coupled to the programmable screen, wherein the container computer system comprises:
one or more memory devices with computer-readable program code stored thereon; and
one or more processing devices operatively coupled to the one or more memory devices, wherein the one or more processing devices are configured to execute the computer-readable program code to:
receive replacement transport information based on a product decision from a receiving entity, wherein the replacement transport information corresponds to a container return location for the reusable container, a product return location for the product, or an alternate product location for transporting an alternate product; and
update the programmable screen with the replacement transport information.

2. The reusable container of claim 1, wherein the replacement transport information is received from an entity interface.

3. The reusable container of claim 2, wherein the replacement transport information received from the entity interface comprises receiving the replacement transport information from a graphical user interface of a receiving entity computer system.

4. The reusable container of claim 1, the one or more processing devices are further configured to execute the computer-readable program code to:
receive the transport information from a transport system for transporting the product to the receiving entity; and
update the programmable screen with the transport information.

5. The system of claim 1, wherein the programmable screen comprises an electrophoretic screen.

6. The system of claim 1, wherein an energy source is operatively coupled to the container computer system to update the programmable screen, wherein the energy source may be integrally or removably operatively coupled to the container computer system.

7. The system of claim 6, wherein the energy source comprises a low voltage energy supply, a printed battery, or a resonance coil and one or more capacitors.

8. The system of claim 1, further comprising:
a vacuum housing operatively coupled to the container housing, wherein the vacuum housing secures the programmable screen.

9. The system of claim 1, wherein the container computer system comprise a low-profile motherboard.

10. The system of claim 1, wherein the programmable screen provides container information comprising transport information, branding information, and advertisement information.

11. The system of claim 1, wherein the container housing is a flexible container or a ridged container.

12. The system of claim 1, further comprising:
a securing system operatively coupled to the container housing, the securing system comprising:
a closing device operatively coupled to the container; and
a locking device configured for operative coupling with the closing device to aid in preventing use of the closing device.

13. A reusable container transport system, the system comprising:
one or more memory devices with computer-readable program code stored thereon; and
one or more processing devices operatively coupled to the one or more memory devices, wherein the one or more processing devices are configured to execute the computer-readable program code to:
send a product decision from an entity interface to a transport system, wherein the product decision comprises acceptance of a product, return of the product, or sending of an alternate product;
receive alternate transport information based on the product decision, wherein the alternate transport information corresponds to a container return location for a reusable container, a product return location for the product, or an alternate product location for transporting the alternate product; and
provide the alternate transport information to a container system of the reusable container for updating a programmable screen of the reusable container.

14. The system of claim 13, wherein the programmable screen comprises an electrophoretic screen, and wherein an energy source is integrally or removably operatively coupled to the programmable screen for updating the programmable screen.

15. The system of claim 13, wherein the programmable screen provides container information comprising transport information, branding information, and advertisement information.

16. A reusable container transport system, the system comprising:
one or more memory devices with computer-readable program code stored thereon; and
one or more processing devices operatively coupled to the one or more memory devices, wherein the one or more processing devices are configured to execute the computer-readable program code to:
receive a product decision from an entity interface, wherein the product decision comprises acceptance of a product, return of the product, or sending of an alternate product;
identify replacement transport information based on the product decision, wherein the replacement transport information corresponds to a container return location for a reusable container, a product return location for the product, or an alternate product location for transporting the alternate product; and
provide the replacement transport information to a container computer system of the reusable container or to an entity interface that communicates with the container computer system for updating a programmable screen of the reusable container.

17. The system of claim 16, wherein the programmable screen comprises an electrophoretic screen, and wherein an energy source is integrally or removably operatively coupled to the programmable screen for updating the programmable screen.

18. The system of claim 16, wherein the programmable screen provides container information comprising transport information, branding information, and advertisement information.

19. A method of processing reusable containers using a reusable container transport system, the method comprising:
receiving, by one or more processors, a product decision from an entity interface, wherein the product decision comprises acceptance of a product, return of the product, or sending of an alternate product;
identifying, by the one or more processors, replacement transport information based on the product decision, wherein the replacement transport information corresponds to a container return location for a reusable container, a product return location for the product, or an alternate product location for transporting the alternate product; and
providing, by the one or more processors, the replacement transport information to a container system of the reusable container or to an entity interface that communicates with the container system for updating a programmable screen of the reusable container.

20. The method of claim 19, wherein the programmable screen comprises an electrophoretic screen, and wherein an energy source is integrally or removably operatively coupled to the programmable screen for updating the programmable screen.
